(19) United States
(12) Patent Application Publication
(10) Pub. No.: US 2008/0208951 A1
(43) Pub. Date: Aug. 28, 2008

(54) Method for Processing Mailed Items

(75) Inventors: Christine Gotz, Brensbach (DE); Torsten Plankert, Dinslaken (DE); Sandra Meuer, Essen (DE); Silvia Buchner, Sprockhovel (DE)

Correspondence Address: International IP Law Group, P.O. BOX 691927, HOUSTON, TX, 77269-1927, US

(73) Assignee: DEUTSCHE POST AG, Bonn, DE (DE)

(21) Appl. No.: 11/917,618

(22) PCT Filed: Jun. 16, 2006
(86) PCT No.: PCT/EP2006/005766

§ 371 Date: Mar. 12, 2008

(30) Foreign Application Priority Data
Jun. 16, 2005 (EP) 05012996.4

(51) Int. Cl. G06F 15/16

(52) U.S. Cl. 709/201

(57) ABSTRACT

An exemplary method for processing mailpieces is adapted to be performed in a data network having a plurality of processing units connected to each other within the data network, wherein an image of a surface of the mailpiece is recorded in a first one of the plurality of processing units, and wherein mailing data associated with the mailpiece is ascertained from the image of the surface in other of the plurality of processing units, and wherein a process order is determined in which the mailing data is ascertained by the plurality of processing units. The exemplary method comprises storing first information about a second one of the plurality of processing units, the second one of the plurality of processing units either preceding or following the first one of the plurality of processing units in the process order, providing connection information for establishing a data connection between the first one of the plurality of processing units and the second one of the plurality of processing units, the connection information being associated with the first information, and employing the connection information to establish a data connection between the first one of the plurality of processing units and the second one of the plurality of processing units to transmit the image therebetween.

### CROSS REFERENCE TO RELATED APPLICATIONS

Pursuant to 35 U.S.C. § 371, this application is the United States National Stage Application of International Patent Application No. PCT/EP2006/005766, filed on Jun. 16, 2006, the contents of which are incorporated by reference as if set forth in their entirety herein, which claims priority to EP Patent Application No. 05012996.4, filed Jun. 16, 2005, the contents of which are incorporated by reference as if set forth in their entirety herein.

### BACKGROUND

The invention relates to a method for processing a mailpiece in which an image of a surface of the mailpiece is recorded in a processing unit, and mailing data that is associated with the mailpiece is ascertained from the image of the surface in other processing units.

For purposes of transporting mailpieces to their destination addresses, the mailpieces are normally collected at the outgoing location in a distribution center of a postal service provider and, within the scope of the outgoing sorting, are associated with the distribution center at the destination. Then, at the destination, sorting is carried out according to the delivery zones of the destination and according to the delivery sequence within the delivery zones, that is to say, according to the sequence in which the destination addresses are serviced by a deliverer.

In this context, the processes for sorting the mailpieces are highly automated, whereby a plurality of processing units are employed for sorting and for ascertaining the information required for the sorting in a distribution center.

As a rule, first of all, an image of the mailpiece surface is recorded in a scanning device, and it is then transferred to a coding system in which the recipient address is read. Here, the coding system comprises multiple automatic address readers and multiple video coding stations at which the address is ascertained by the video coding personnel if it was not possible for it to be read automatically. Moreover, processing units are used in order to automatically ascertain the weight and the dimensions of a mailpiece as well as to check the postage.

The automatically ascertained mailing data such as, for example, the coded addresses, the weight and the dimensions as well as the validity of the franking are then transferred to a sorting machine so that it can perform the sorting of the mailpieces on the basis of this data.

The data is associated with the mailpieces on the basis of an identification code that is applied onto the mailpieces or else the mailpieces are situated in a storage area of the sorting machine while the mailing data is being automatically ascertained.

As a rule, the processing units in a distribution center are controlled by a central control device that transmits the image of the mailpiece surface to the processing units required for the processing and that makes the processing results ascertained by the processing units available to the sorting machines.

The central control device is equipped with numerous functionalities in order to perform these tasks and is consequently highly complex. There is a great risk that, if the control unit malfunctions, the entire mail processing in the distribution center will be disrupted.

Another drawback is that the central control devices only control the processing units of one distribution center so that the exchange of mailing data among processing units in different distribution centers, for example, in the distribution center of the outgoing location and in the distribution center of the destination, can only take place via the central control devices of these distribution centers.

For this purpose, another interface of the central control device is required and an evaluation of the mailing data record is required in each control unit, as a result of which the control of the data flow during the processing of the mailing data is complicated and laborious when it comes to data exchange spanning multiple locations.

Likewise, for example, in German Preliminary Published Application DE 43 24 255 A1, it has already been proposed to carry out the video coding in a video coding center if the capacity in a given distribution center is not sufficient.

However, the integration of a video coding center by means of the known control devices in the distribution centers is highly intricate.

### SUMMARY OF THE INVENTION

It is an objective of the invention to create a method for processing mailing data of the above-mentioned type in which the mailing data can be exchanged among processing units in a simple manner. In particular, a simple data exchange spanning multiple locations should also be possible.

According to an exemplary embodiment of the present invention, it is provided that a method is carried out in such a way that the processing units are connected to each other within a data network and a process order is determined in which the mailing data is ascertained by the processing units, that first information about at least one other processing unit that precedes and/or follows in the process order is stored in the processing units, that connection information for establishing a data connection to a second processing unit is associated with the first information, whereby the connection information is provided by a management unit, and that a first processing unit uses the connection information in order to establish a data connection to the second processing unit in order to transmit the image to the second processing unit or to retrieve the image from the second processing unit.

Advantageously, the data communication here, i.e., the exchange of mailing data, takes place directly between two processing units, that is to say, it is decentralized. In this manner, the mailing data can be sent from one processing unit directly to the processing unit that follows in the process order specified for the processing of the mailing data record, or else this data can be retrieved from a processing unit that precedes in the process order, as a result of which the data transmission processes in a mail processing center are greatly simplified.

In particular, the method can be carried out independently of whether the processing unit that precedes or follows in the process order is located in the same mail processing center or in a different one. The connection to this processing unit is established in the same manner in both cases.

Thus, the exchange of mailing data among the processing units and especially the data exchange spanning multiple locations is greatly simplified and, to a greater extent, take into account the processes that are likewise carried out spanning multiple locations during the processing of mailing data.

In this method, the central management unit merely has the task of managing and providing connection information, as a result of which it can be configured much more simply than a central unit that handles the data communication among the processing units.

Consequently, the central management unit is less prone to malfunction, as a result of which the availability of the entire processing system in a mail processing center of a postal service provider is enhanced.

Moreover, the method according to an exemplary embodiment of the present invention is based on the concept of a so-called abstraction, whereby the processing units do not have to have the connection information for establishing a data connection to other processing units. This information is provided by the management unit.

Therefore, advantageously, the connection information only has to be adapted in the management unit if connection information for establishing a data connection to a given processing unit changes, which can be the case, for instance, if a processing unit of a mail processing center malfunctions and is replaced by a processing unit having the same functionality in another mail processing center or else if a processing unit is to be integrated into or removed from the system.

Thus, the entire processing system is very flexible, which also results in a high availability, since the system, especially in case of a malfunction, can be easily and quickly adapted.

In a preferred embodiment of the invention, it is provided that, in the data network, processing units are connected to each other that are located in at least two different mail processing centers.

Within the scope of the invention, a mail processing center can be any processing center for processing the physical mailpiece and/or the image of the mailpiece surface that is operated by a postal service provider. In particular, it can be a distribution center in which, for example, the incoming or outgoing sorting of the mailpieces is carried out, or else it can be a video coding center.

In another advantageous exemplary embodiment of the present invention, the image of the surface of the mailpiece is contained in a mailing data record that is augmented in the processing units by the mailing data ascertained from the image.

In this manner, the image of the surface of the mailpiece can be transferred to the various processing units in a prescribed order, whereby the processing units consecutively augment the mailing data record so that, after the processing of the mailing data record in the last processing unit in the process order, a mailing data record containing all of the mailing data needed for the sorting is on hand.

Preferably, it is provided that the first processing unit transmits the mailing data record to the second processing unit or retrieves the mailing data record from the second processing unit.

Consequently, the data communication advantageously takes place within the scope of a push-oriented or pull-oriented data transmission, i.e. during the transmission, either the sender or the recipient of the mailing data record is active.

Advantageously, in one exemplary embodiment of the present invention, it is provided that the first processing unit transmits the first information to the management unit, that the connection information is associated with the first information within the management unit, and that the management unit transmits the connection information to the first processing unit.

In a likewise advantageous exemplary embodiment of the present invention, it is provided that the management unit transmits the connection information to the first processing unit and that the association between the first information and the connection information is carried out within the first processing unit.

In another preferred embodiment of the invention, it is provided that the first information about the other processing units that is stored in the first processing units comprises information about the functionality of the other processing units.

This is advantageously generic information about the other processing units so that the management unit can select the connection information for establishing the data connection to another processing unit from several items of connection information for establishing a data connection to processing units having the same functionality. The flexibility of the method is thus enhanced.

In another especially advantageous exemplary embodiment of the present invention, it is provided that the processing units log on to the management unit.

By logging on to the management unit, a processing unit makes its functionality available to other processing units that can retrieve from the management unit the connection information for establishing a data connection to a processing unit that is logged on to the management unit.

Preferably, it is provided that, at the time of the logon, a processing unit transmits first registration information to the management unit, whereby the first registration information comprises information about the functionality of this processing unit as well as connection information for establishing a data connection to this processing unit.

Advantageously, the association between the first information and the connection information for establishing a data connection to the second processing unit is made using the first registration information.

In another advantageous exemplary embodiment of the present invention, it is also provided that, at the time of the logon, a processing unit transmits second registration information to the management unit, whereby the second registration information comprises information about other processing units that immediately precede or follow in the process order.

This information corresponds to the segment of the process order from which the position of a processing unit within the process order is unambiguously indicated.

Here, it is preferably provided that, on the basis of the second registration information, the management unit ascertains the position of a processing unit within the process order and incorporates this processing unit into the process order.

As a result, the processing system is capable of “plug-and-play”, that is to say, at the time of a logon, the management unit recognizes the type of a processing unit that is logging on and the way in which it has to be integrated into the process order, without said processing unit having to have this information itself or without this information having to be provided or entered by a third party such as, for example, an administrator.

Moreover, in this manner, the process order is generated as a function of the processing units that are actually present and that are logged on to the management unit. Consequently, at the time of a logon, an appropriate adaptation of the process order is carried out.

In another advantageous exemplary embodiment of the present invention, it is provided that the management unit transmits the process order to the processing units.

As a result, the processing units always have the current process order in which all of the processing units that are logged on to the management unit are taken into account.

It is also advantageously provided that, on the basis of the process order received from the management unit, a processing unit ascertains the first information about the other processing units that precede and/or follow in the process order.

In this manner, the processing units ascertain their own position in the process order on the basis of the current process order and, in doing so, determine especially the current processing units that precede or follow in the process order.

Preferably, the first information contains information about all of the other processing units that precede a given processing unit in the process order and from which the mailing data record is retrieved.

Moreover, preferably, the first information contains information about all of the other processing units that follow a given processing unit in the process order and to which the mailing data record is transmitted.

Consequently, in this exemplary embodiment of the invention, the first information differs from the second information that the processing units preferably transmit to the management unit at the time of the logon in that the first information contains not only information about the processing units that immediately precede and follow in the process order, but also information about all other processing units present in the process order from which the mailing data record can be retrieved or to which the mailing data record can be transmitted.

Here, it is preferably provided that, in each case, a processing unit assigns a priority to the first information about the other processing units that follow in the process order, whereby the priorities are reduced in the order in which the following processing units follow this processing unit in the process order.

Consequently, on the basis of the priorities specified in this manner, the processing unit that immediately follows in the process order, and then the following processing unit, etc. can be identified, whereby the priority is reduced for each subsequent successor.

Preferably, it is also provided that, in each case, a processing unit assigns a priority to the first information about the other processing units that precede in the process order, whereby the priorities are reduced in the order in which the processing units precede this processing unit in the process order.

Consequently, on the basis of the specified priority, the processing unit that immediately precedes in the process order, and then the preceding processing unit, etc., can all be identified, whereby the priority is reduced for the earlier predecessors.

A preferred embodiment of the invention is characterized in that the first processing unit establishes a data connection to a second processing unit having a lower priority that precedes or follows in the process order if the establishment of a data connection to a processing unit having a higher priority that precedes or follows in the process order is unsuccessful.

In this manner, a failure safety capacity is advantageously created, whereby the processing units establish a data connection to the subsequent preceding or following processing unit if the establishment of a data connection to a given processing unit is unsuccessful. This ensures that the data flow is not interrupted if a processing unit malfunctions.

In another preferred embodiment of the invention, it is provided that, in the processing units for other processing units that precede and/or follow in the process order, transmission conditions are stored under which the mailing data record is transmitted to the other processing units or retrieved from the other processing units.

On the basis of the transmission conditions, it can be decided to which of the processing units that immediately follow in the process order the mailing data record is to be transmitted under certain conditions, or from which of the processing units that immediately precede in the process order the mailing data record is to be retrieved under certain conditions.

Preferably, the transmission conditions refer to mailing data contained in the mailing data record.

Thus, it can be specified, for example, for an automatic address reader, that the mailing data record is to be transferred to a video coding station if prescribed address components could not be incorporated into the mailing data record by the automatic address reader.

In an advantageous exemplary embodiment of the present invention, it is likewise provided that, in a processing unit, several items of first information are stored about second processing units that precede and/or follow the processing unit in the process order and that have different functionalities, whereby different transmission conditions are specified for the second processing units.

In a likewise advantageous exemplary embodiment of the present invention, it is also provided that, in a processing unit, several items of first information are stored about second processing units that precede and/or follow this processing unit in the process order and that have different functionalities, whereby the same priority is assigned to the second processing units and different transmission conditions are specified for the second processing units.

Here, advantageously in the first processing unit, a second processing unit to which the mailing data record is transmitted or from which the mailing data record is retrieved is ascertained on the basis of the transmission conditions specified for the second processing units.

In another especially preferred embodiment of the invention, it is provided that a management unit is located in every mail processing center and that the processing units log on to the management unit of the mail processing center in which they are operated.

In this manner, each mail processing center can also be operated autonomously.

In order for the registration information of processing units in a mail processing center to also be present in another mail processing center, it is preferably provided for the registration information to be exchanged among the management units of the mail processing centers.

Moreover, it is advantageously provided that the first processing unit transmits the first information to the management unit of the mail processing center in which it is being operated.

Advantageously, the connection information for establishing the data connection to the second processing unit comprises a network address of the second processing unit.

### BRIEF DESCRIPTION OF THE DRAWINGS

FIG. 1 is a schematic representation of a network with networked processing units and with a management unit in a mail processing center in accordance with an exemplary embodiment of the present invention;

FIG. 2 is a schematic representation of a network with networked processing units and with a management unit in each of two mail processing centers in accordance with an exemplary embodiment of the present invention;

FIG. 3 is a schematic representation of the structure of a management unit in accordance with an exemplary embodiment of the present invention;

FIG. 4 is a flow diagram in which the generation of a new process order is illustrated in accordance with an exemplary embodiment of the present invention;

FIG. 5 is a schematic representation of various groups of processing units in accordance with an exemplary embodiment of the present invention;

FIG. 6 is a schematic representation of a load balancing unit integrated into a management unit, and several processing units in accordance with an exemplary embodiment of the present invention; and

FIG. 7 is a schematic representation with a management unit and several processing units that each have a load balancing unit in accordance with an exemplary embodiment of the present invention.

### DETAILED DESCRIPTION OF SPECIFIC EMBODIMENTS

When mailpieces are processed, outgoing sorting is normally carried out in a distribution center at the place of origin of the mailpieces and incoming sorting is carried out in a distribution center at their destination. During the outgoing sorting, the mailpieces are sorted at the mail processing centers according to the destinations, whereas the incoming sorting comprises sorting the mailpieces according to the delivery sequence at the destination.

Address information as well as further data that is relevant for the sorting or for the transport of the mailpieces such as, for example, whether the postage is correct, are ascertained by processing units that are connected data-wise to the sorting devices.

An image of the mailpiece surface is transferred to the processing units from which, depending on their functionality, they ascertain the information needed for the sorting. Here, a distinction has to be made between online processing, in which the mailpieces are located within a storage segment in the sorting machine during the processing of the image, and offline processing, in which the mailpieces are not situated in the sorting machine during the processing of the image.

During the offline processing, the image or the information ascertained from the image is associated with the physical mailpiece by means of an unambiguous ID code that is printed onto the mailpiece and associated with the image.

In this context, the invention can be used equally for online as well as for offline processing.

Address information is ascertained in a coding system comprising several processing units. These are especially automatic address readers in which the address information is automatically read by means of OCR software and a video coding system with multiple video coding stations to which the image of the mailpiece surface is transferred if a reading attempt in an automatic address reader is unsuccessful.

Moreover, the image is fed to an automatic postage reader in which an automatic postage verification is carried out, and additional processing units can be provided such as, for example, automatic forwarding elements in which it is ascertained whether there is a forwarding order for the mailpiece.

The processing units can be operated in the distribution centers of a postal service provider or in other mail processing centers. In particular, in at least one mail processing center, this can also be a video coding center to which the video coding operation has been allocated for some or for all of the distribution centers.

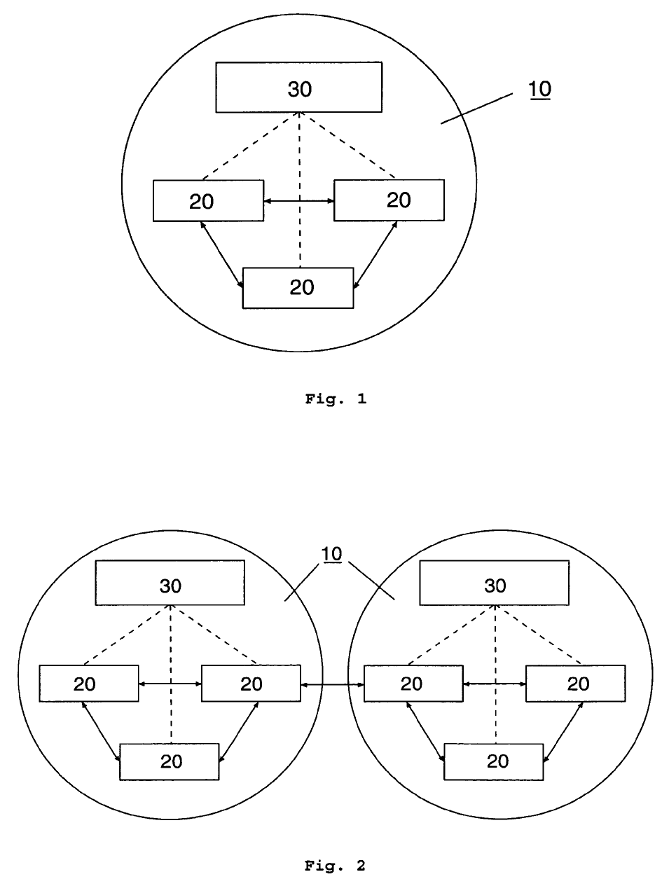

As schematically shown in FIG. 1, within the scope of the invention, it is provided that the processing units 20 in a mail processing center 10 are connected to each other within a data network.

Here, the processing units 20 make their functionalities available within the network in the form of so-called CORBA objects that can be used or called by other processing units 20. In principle, CORBA objects and their use are known to the person skilled in the art.

The data communication within the network illustrated in FIG. 1 by the solid lines, that is to say, the exchange of mailing data, preferably takes place directly between the processing units 20.

Consequently, the network is a so-called peer-to-peer network in which, on the one hand, the processing units 20 make services available and in which, on the other hand, they make use of services of other processing units 20.

Any desired processing units 20 that are provided for ascertaining mailing data from the image of the surface of a mailpiece can be integrated into the data network.

The sorting machines or control systems for the sorting machines that feed in the acquired images of the mailpiece surfaces into the data network and to which the information ascertained from the image is transmitted for purposes of sorting the mailpieces can likewise be incorporated into the data network.

Here, it is provided that, during the processing of a mailpiece, first of all, a mailing data record containing the image of the mailpiece surface is generated, and said mailpiece data record is augmented by the processing units 20 by mailing data in each case, especially by mailing data ascertained from the image such as, for example, the name and components of the address of the recipient or the correctness of the postage.

The complete mailing data record, that is to say, containing all of the relevant information, is then transmitted to the control systems of the sorting machines or group of sorting machines provided for the sorting so that the mailpieces can be sorted on the basis of the mailing data.

In addition to the image of the mailpiece surface, the mailing data record also includes further data elements such as, for example, the weight, the dimensions, the postal code, the name, the street and the house number of the recipient as well as data elements pertaining to the correctness of the postage. Moreover, the mailing data record preferably contains information of the mail processing center 10 where the mailpiece in question was received.

Preferably, the mailing data record also contains an unambiguous ID number with which the appertaining mailpiece is also provided. During the sorting of the mailpiece, the ID number is recorded in the sorting machine and the mailing data record containing the read-in ID number is ascertained from which the mailing data is then read out and on the basis of which the sorting is carried out. In the case of online processing, however, this ID number can be dispensed with.

The values of the data elements are ascertained by the processing units 20 on the basis of their functionalities and stored in the mailing data record, whereby the mailing data record is consecutively transferred in a prescribed process order to the processing units 20 having different functionalities.

Here, transfer conditions are specified for the values of the data elements and, if such conditions are present, the mailing data record is transferred from a processing unit 20 having a first functionality to a processing unit 20 having a second functionality.

If one looks, for example, at the coding of the delivery address as a partial process within the entire process order, then the mailing data record is first transmitted to an automatic address reader. If the delivery address cannot be ascertained within a prescribed period of time in this automatic address reader, then the mailing data record is transferred to a video coding station. Otherwise, it is sent by the automatic address reader, for example, to a postage reader that checks the correctness of the postage on the basis of the ascertained delivery address.

In order to transfer the mailing data record to a processing unit 20 that follows in the process order or to retrieve it from a processing unit 20 that precedes in the process order, connection information is needed that especially comprises the network address of this processing unit 20 as well as the port address of the service it provides.

This information is provided to the processing units 20 by a management unit 30 at which the processing units 20 of the mail processing center 10 are registered.

In addition to the described network in a first mail processing center 10, FIG. 2 shows another network in a second mail processing center 10 in which processing units 20 are likewise networked and can be connected to each other data-wise.

The second mail processing center 10 likewise has a management unit 30 that provides the processing units 20 with the connection information.

In order to permit data communication among the processing units 20 spanning multiple processing centers, the management units 30 of the mail processing centers 10 exchange registration information of the processing units 20 that are registered at a given mail processing center 10.

In order to retrieve a mailing data record from a processing unit 20 of the other mail processing center 10 or to transmit the mailing data record to a processing unit 20 of the other mail processing center 10, a processing unit 20 receives the connection information from the management unit 30 of its own mail processing center 10.

In the same manner, the processing units 20 of any desired number of mail processing centers 10 can be networked within a group, whereby each mail processing center 10 preferably has its own management unit 30 and the various management units 30 exchange registration information among each other.

Hence, each mail processing center 10 can be operated autonomously by means of its own management unit 30. However, mailing data records can also be exchanged among processing units 20 spanning multiple processing centers.

In order to make their functionalities available to other processing units 20, the processing units 20 of a given mail processing center 10 log on to the management unit 30 of that mail processing center 10 and are registered there.

At the time of the logon of a processing unit 20, the management unit 30 especially has the task of generating a process order (PcO) for consecutively processing the mailing data record by the logged-on processing units 20 and to group the logged-on processing units 20 having the same functionalities into a processing unit group. For this purpose, the management unit 30 has a PcO manager 40 and a grouping component 50.

In order to generate the process order, at the time of a logon, a processing unit 20 transmits a service PcO to the management unit 30, whereby said PcO is part of the configuration of the processing unit 20 and is stored in a memory at the time of the programming.

Moreover, at the time of the logon, a processing unit 20 transmits information about its functionality, its network address and the port address at which the service it provides can be accessed.

The service PcO especially contains a generation date or a version number, on the basis of which the PcO manager 40 can always determine the current service PcO for processing units 20 having the same functionalities and can take this into account when the process order is generated.

The service PcO also contains information about the functionality of the processing unit 20 or another generic designation of the processing unit 20. The way in which a certain processing unit 20 such as, for example, a video coding station or its functionality are to be designated here is prescribed in a uniform manner within the entire network, spanning multiple processing centers.

Moreover, the functionalities of processing units that immediately precede and follow a given processing unit 20 in the process order are indicated in the service PcO.

These are the processing units 20 that immediately precede and/or follow a given processing unit 20 within the prescribed process order.

A processing unit 20 contains mailing data records especially of the immediately preceding processing unit and, after the processing, transfers this information especially to the following processing unit.

Therefore, the service PcO of a processing unit 20 indicates the possible “routes” that a mailing data record can take within the process order towards a processing unit 20 as well as away from a processing unit 20.

In particular, in addition to the functionality, a transmission modality as well as one or more transmission conditions are indicated in the service PcO of a processing unit 20 for each preceding and following processing unit.

The transmission modality specifies whether the mailing data record is transferred from the preceding processing unit and to the following processing units within the scope of a push-oriented or pull-oriented transmission method.

In the case of the push-oriented transmission method, the transmission is initiated by the sender of the mailing data record, that is to say, the mailing data record is sent from a first processing unit 20 to a second processing unit 20 that follows in the process order.

In the case of pull-oriented transmission method, the transmission is initiated by the recipient of the mailing data record, that is to say, the second processing unit 20 that follows in the process order retrieves the mailing data record from the first processing unit 20.

On the basis of the transmission conditions, it is specified under which conditions a mailing data record is retrieved by a processing unit 20 from a processing unit 20 that precedes it in the process order or under which conditions a mailing data record is transmitted by a processing unit 20 to a processing unit 20 that follows it in the process order.

Here, the transmission conditions preferably relate to the data elements in the mailing data record, whereby, for example, certain limit values or data formats can be specified so that, if they are present, the mailing data record should go to a processing unit 20 that follows in the process order or, if they are present, said mailing data record precisely should not go to the following processing unit 20.

The transmission conditions are of special significance when a processing unit 20 has multiple immediately preceding or following processing units to which the mailing data record is transferred under various conditions or from which the mailing data record is retrieved under various conditions.

An example of such a processing unit 20 is an automatic address reader whose immediately following processing units are a video coding station and an automatic postage reader or an automatic forwarding element.

On the basis of the transmission conditions, it can be indicated that a mailing data record is only to be transmitted to a video coding station if at least one of the data elements of the mailing data record that describes the recipient address has a value of zero or is empty after the mailing data record has been processed in the automatic address reader, since its value could not be automatically recognized.

Moreover, the possibility exists that, within an old process order, a data communication between the processing unit that, in the current process order, immediately precedes a given processing unit 20 and another processing unit 20 exists, whereby said data communication is to be replaced in the new process order that is generated on the basis of the service PcO.

Therefore, it can be indicated in the service PcO that there is a need to eliminate a communication route between an immediately preceding processing unit and another processing unit 20 having a certain functionality that has to be specified.

If, in an old process order, a data communication already exists between the immediately preceding processing unit and another processing unit 20 and if it is not indicated in the service PcO that the communication route is to be eliminated, then the communication route is retained as an alternative communication route in the process order that is to be newly generated.

For the immediately following processing units, information about obsolete communication routes is not necessary since all of the following processing units are already indicated in the service PcO and such a replacement is thus carried out—so to speak automatically—on the basis of the information in the service PcO.

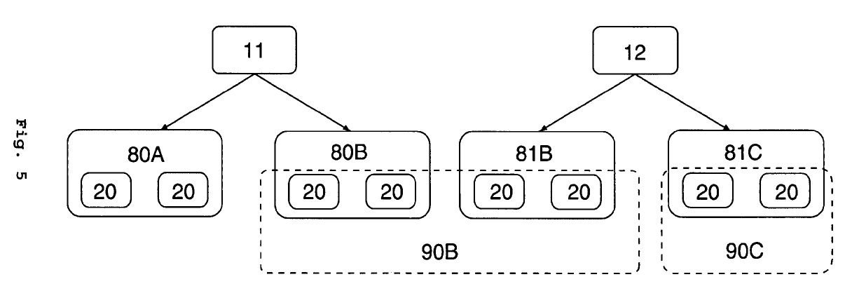

The generation of a new process order undertaken in the PcO manager 40 is illustrated in FIG. 4.

The service PcO that is transmitted to the management unit 30 at the time of a logon of a processing unit 20 is transferred to the PcO manager 40 which, on the basis of the service PcO, first ascertains in Step 410 the functionality of the processing unit 20 that is logging on and checks in Step 420 whether a device PcO for a processing unit 20 having the same functionality is already present and has been used for the generation of the existing process order.

If this is not the case, then a new process order is generated making use of the service PcO which, for this purpose, is incorporated in Step 430 into the existing process order.

If a service PcO for a processing unit 20 having the same functionality is already present, then, in Step 440, the generation date of the service PcO is ascertained and in Step 450, it is checked whether it is more recent than the generation date of the existing service PcO.

If the service PcO of the processing unit 20 that is logging on is more recent than the existing service PcO, then a new process order is generated, and the PcO manager 40 proceeds to Step 430. In case of an older generation date, the service PcO is discarded in Step 460.

This ensures that the process order is always based on the latest service PcO for the processing units 20 having the same functionalities.

The new process order is generated by the PcO manager 40 in Step 430 on the basis of the information about the preceding and following processing units in the service PcO, whereby said information unambiguously describes the position that the processing unit 20 that is logging on should assume in the process order.

In particular, the processing unit 20 that is logging on is placed in the process order between the processing units that precede and that follow in the process order as indicated in the service PcO.

If no preceding or following processing units are indicated in the service PcO of a processing unit 20, then this processing unit 20 marks the starting point or end point of the process order.

In Step 470, it is checked whether the incorporation of the service PcO into the process order has taken place without error, that is to say, especially whether an unambiguous and interruption-free route from the starting point to the end point is prescribed in the process order for the mailing data record.

If this is not the case, for example, due to incomplete or erroneous information in the service PcO, then the PcO manager 40 proceeds to Step 460 and the service PcO is discarded.

If the service PcO was incorporated error-free into the process order, the management unit 30 initiates a reconfiguration (still to be described) of all of the processing units 20 of its own mail processing center 10, including the processing unit 20 that is logging on.

Moreover, even if the service PcO has been discarded, a response to the logon is transmitted to the processing unit 20 that is logging on, whereby this response contains the current process order as well as the service PcO that was used to generate the valid process order for the processing units 20 having the same functionality as the processing unit 20 that is logging on.

However, no reconfiguration is initiated since no changes result within the process order for the other processing units 20.

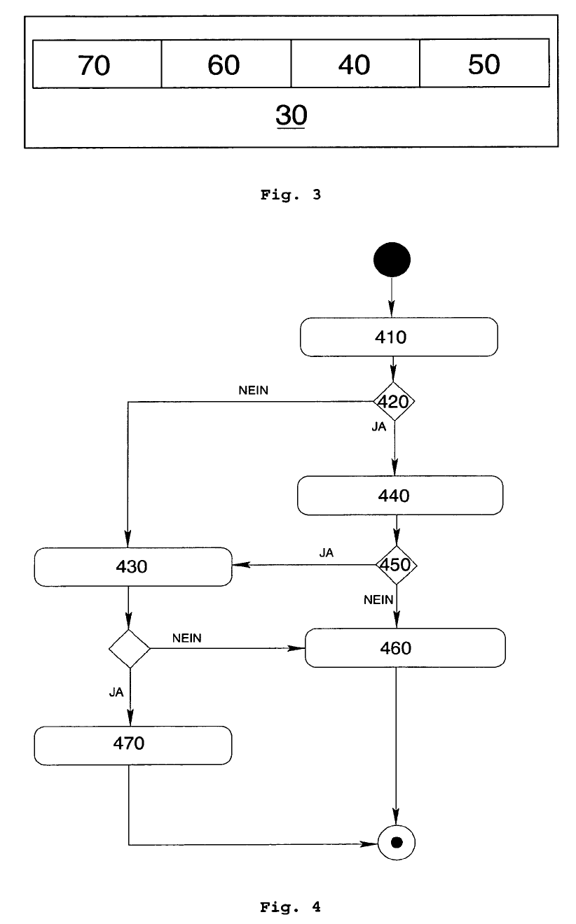

Preferably, in order to reconfigure the processing units 20, a reconfiguration event is triggered in the event handler of the management unit 30, which is designated with the reference numeral 60 in FIG. 3.

The event handler 60 generally serves to transmit management information such as especially the process order from the management unit 30 of a mail processing center 10 to the processing units 20 of this mail processing center 10, whereby the processing units 20 can each register themselves for the occurring management events. The registration for the reconfiguration event is obligatory for all of the processing units 20.

If a processing unit 20 receives a new process order in response to the logon or because of a reconfiguration event, this new process order is transferred within the processing unit 20 to a PcO worker that identifies the processing unit 20 within the process order on the basis of its functionality and ascertains from the process order the information that is relevant for the processing unit 20.

The PcO worker extracts a “section” from the process order that—like the service PcO of a processing unit 20—contains information about the functionality of the processing units that immediately precede or follow a processing unit 20 in the process order as well as the transmission modalities and transmission conditions associated with the processing units that immediately precede or follow.

Furthermore, however, the section of a processing unit 20 also contains information about the functionalities and transmission conditions for all of the processing units 20 that precede in the process order all the way to the starting point and that have at least one immediately following processing unit that retrieves mailing data records from these processing units 20 in a pull-oriented transmission method.

This information is assigned a priority that reflects the position in the process order of such a processing unit 20 that precedes in the process order.

The first processing unit that precedes in the process order from which mailing data records are retrieved in a pull-oriented method receives Priority 1, the next processing unit that precedes in the process order and that is addressed via a polling method by at least one of its immediately following processing units receives Priority 2, and so forth.

If an instance with multiple processing units 20 exists in the process order from which units the mailing data records are retrieved in a pull-oriented transmission method, that is to say, if several such processing units 20 exist that can alternatively process mailing data records, then these processing units 20 receive the same priority.

The section of a processing unit 20 also contains information about the functionalities of all of the processing units 20 that follow this processing unit 20 in the process order as well as information about the transmission conditions that are associated with these processing units 20.

In an analogous manner, a priority is assigned to each of the processing units 20 that follow in the process order, whereby this priority indicates the position of the processing unit 20 in the process order. The immediately following processing units receive Priority 1, the processing units 20 that immediately follow these processing units 20 in the process order receive Priority 2, and so forth.

On the basis of this information, a processing unit 20 can retrieve mailing data records from a preceding processing unit having a low priority if a processing unit 20 having a higher priority malfunctions. By the same token, said processing unit 20 can transmit mailing data records to following processing units having a lower priority if a processing unit 20 having a higher priority malfunctions.

This ensures that the data flow is not interrupted, even if a processing unit 20 malfunctions.

Another task of the management unit 30 of a mail processing center 10 is to group registered processing units 20 having the same functionality.

Within a mail processing center 10, the processing units 20 that are registered in the management unit 30 and that are operated in the mail processing center 10 are grouped by the grouping component 50 of the management unit 30 into local processing unit groups, whereby the various processing unit groups each comprise processing units 20 having the same functionality.

In the grouping component 50, a service list is generated for each local processing unit group, said service list comprising the connection information for the processing units 20 of the processing unit group.

The association of a processing unit 20 with a processing unit group is preferably carried out at the time of the logon on the basis of the information about the functionality of the processing unit 20 that is transmitted to the management unit 30 at the time of the logon.

After the association has been carried out, the connection information likewise transmitted at the time of the logon is stored in the service list of the processing unit group with which the processing unit 20 has been associated.

If no processing unit group exists for the functionality of the processing unit 20 that is logging on, then such a group is created with an appertaining service list.

Moreover, in the grouping component 50, it is specified for each local processing unit group or for each service list whether the contained processing units 20 can be accessed exclusively by other processing units 20 of the same mail processing center 10 or whether the access can also be global, that is to say, by processing units 20 of other mail processing centers 10.

Moreover, for each processing unit 20, it can be specified individually whether it is available locally or globally, whereby this information is preferably transmitted to the management unit 30 at the time of the logon of a processing unit 20.

Consequently, a global processing unit group within a mail processing center 10 can also include processing units 20 that can only be accessed locally. Here, the term global is taken to mean a processing unit group comprising at least one processing unit 20 that is globally accessible.

Processing units 20 that are no longer available for ascertaining or processing mailing data log off from the management unit 30.

A logoff is sent to the management unit 30, for example, when maintenance work is to be done to a processing unit 20 or if a processing unit 20 in a mail processing center 10 is being permanently removed.

In the case of video coding stations, it can also be provided that they log off from the management unit 30 of the mail processing center 10 in which they are being operated when they are left by the video coding personnel, for example, at the time of a shift change.

The logoff message sent to the management unit 30 for logging off purposes contains information about the functionality of the processing unit 20 that is logging off as well as information about its connection information.

In the management unit 30, a processing unit 20 that is logging off is first identified on the basis of its functionality and it is checked whether multiple processing units 20 having the same functionality as the processing unit 20 that is logging off are registered within a processing unit group.

If this is the case, the processing unit 20 that is logging off or else its connection information is deleted from the service list of the processing unit group corresponding to the functionality of the processing unit 20. This is carried out by the grouping component 50.

If the processing unit 20 that is logging off, however, is the only registered processing unit 20 having a certain functionality, a new process order is generated by the PcO manager 40 in which the processing unit 20 that is logging off is no longer contained.

The new process order is then checked in the PcO manager 40, whereby it is especially checked whether, with the process order, an interruption-free and unambiguous route through the production system is prescribed for the mailing data record.

If this is the case, a reconfiguration of the other processing units 20 of the mail processing center 10 is initiated as already described.

Another task of the management unit 30 of a mail processing center 10 is the management of periods of validity (“lease management”) for the registered processing units 20 of the mail processing center 10.

The lease management is carried out by a lease manager 70 of the management unit 30.

The lease manager 70 assigns a period of validity to each processing unit 20, whereby the processing units 20 have to log on to the management unit 30 once again or have to send a prescribed signal to the management unit 30 before the expiration of the period of validity, preferably between the expiration of 0.8 times and 0.9 times the period of validity.

If the renewed logon or the signal of a processing unit 20 is absent, this processing unit 20 is automatically logged off after the expiration of the period of validity.

The period of validity has the same length for all of the processing units 20 of a mail processing center 10. It is preferably between 100 and 500 seconds and starts anew each time it expires.

A processing unit 20 that has newly logged on to the management unit 30 is notified of the period of validity with a response to the logon.

The lease management prevents that the service list contains connection information for processing units 20 that were not logged off, either inadvertently or else due to an error, even though they are not available for processing mailing data records.

In order to allow communication among processing units 20 spanning multiple processing centers, a synchronization of the management units 30 of all of the mail processing centers 10 grouped into a prescribed group is performed. The group can comprise especially all of the mail processing centers 10 that are operated by a given postal service provider.

During the synchronization, management information for the processing units 20 that are registered in the various mail processing centers 10 is exchanged among the management units 30 of the mail processing centers 10.

This is preferably done within the scope of a so-called multicast transmission in which each management unit 30 sends the management information to a multicast address of the network via which the management information is forwarded to the management units 30 of the various other mail processing centers 10.

The synchronization is carried out at regular intervals. Moreover, in an advantageous embodiment of the invention, it can be provided that a management unit 30 also sends the management information to the other management units 30 after a processing unit 20 was logged on to or logged off from this management unit 30.

The management information stored in the management unit 30 of a mail processing center 10, which is made available to the other management units 30 during the synchronization, comprises at least the service lists of the global processing unit groups of a mail processing center 10 or the connection information and functionalities of the processing units 20 of a mail processing center 10, which can be globally accessed.

If at least one processing unit 20 is present in each mail processing center 10 for each task or functionality required to process the mailing data, then this information is sufficient for a synchronization.

However, it can also be provided that processing units 20 with certain functionalities are only present in certain locations 20.

In this case, the management information transmitted during the synchronization to the other management units 30 additionally comprises the service PcOs of the registered globally accessible processing units 20, so that they can be incorporated into the process order in the mail processing centers 10.

In addition to a complete synchronization, it can also be provided, especially in the case of the logging on or off of a processing unit 20 of a specific processing unit group, that, for purposes of synchronization, only the updated service list of the processing unit group in question is transmitted to the other management units 30 or else the management information of a processing unit 20 that is logging on or logging off is transmitted.

The management information received during the synchronization of a management unit 30 is processed in the grouping component 50 and, if applicable, in the PcO manager 40.

The grouping component 50 incorporates into its own corresponding service lists the received connection information for the global processing units 20 having different functionalities.

The connection information of a processing unit 20 is stored in the service lists together with information of the mail processing center 10 in which this processing unit 20 is located.

If, during the synchronization, the service PcO of a processing unit 20 having a functionality for which no processing unit groups exists in the mail processing center 10 is received in the management unit 30 of a mail processing center 10, then the service PcO is transferred to the PcO manager 40.

Like with the local logging on of a processing unit 20, the PcO manager 40 incorporates the service PcO into the process order in the already described manner and triggers a reconfiguration event for the processing units 20 of the mail processing center 10, likewise as already described.

Likewise, a new process order is generated by the PcO manager 40 if, after a synchronization, no more processing units 20 having a given functionality are available, since all of the globally available processing units 20 having this functionality in other mail processing centers 10 have logged off.

In this case, the corresponding processing unit 20 is deleted from the process order and a reconfiguration event is likewise triggered in the mail processing center 10.

In the manner described above, a data network is created spanning multiple processing centers in which processing units 20 having different functionalities are networked with each other, whereby a mailing data record is transferred to the processing units 20 in a prescribed process order within the scope of a peer-to-peer connection, and the processing units 20 augment this record with mailing data. The processing units 20 are incorporated into the process order by means of a plug-and-play mechanism for purposes of processing the mailing data record.

The process order as well as the connection information that is used by a processing unit 20 to establish a data connection to another processing unit 20 that precedes or follows in the process order are managed and made available by the management units 30 of which preferably one is present in each mail processing center 10. Thus, each mail processing center 10 can be operated autonomously.

Advantageously, processing unit groups spanning multiple processing centers exist that, on the one hand, allow a load balancing spanning multiple processing centers and, on the other hand, make it possible to use processing units 20 of another mail processing center 10 to process the mailing data records if processing units 20 having this functionality are not present in a given mail processing center 10.

In this manner, for example, a video coding center to which the video coding of the address data of multiple mail processing centers 10 can be allocated can be integrated into the data network. This video coding center is treated as if it were another mail processing center 10 in which exclusively video coding stations are operated as the processing units 20.

The grouping of local processing unit groups into global processing unit groups, in which the encompassed processing units 20 can be used in a manner spanning multiple processing centers, is illustrated in FIG. 5 with reference to the example of two mail processing centers 11 and 12.

In the situation shown by way of an example, the local processing unit group 80A for the functionality A and the processing unit group 80B for the functionality B exist in the mail processing center 11, whereby the processing units 20 of the processing unit group 80A are accessible only locally whereas the processing units 20 of the processing unit group 80B are accessible globally, i.e. from both mail processing centers 11 and 12.

The processing unit groups 81B and 81C for the functions B and C exist in the mail processing center 12, whereby the processing units 20 of the two processing unit groups 81B and 80C are globally accessible.

Consequently, all in all, this results in an exclusively local processing unit group 80A for functionality A, a global processing unit group 90B for the functionality B consisting of the local processing unit groups 80B and 81B, as well as a global processing unit group 90C for the functionality C consisting only of the local processing unit group 81C.

The communication of the processing units 20 among each other is carried out on the basis of the section of the process order that is generated by processing units 20 in the manner described above and it is subsequently stored in the processing units 20.

Here, a processing unit 20 can establish a data connection to the processing units 20 that precede in the process order and that are indicated in the section and from which the mailing data record is retrieved within the scope of a pull-oriented data transmission, as well as to the processing units 20 that follow in the process order and that are indicated in the section, whereby said units 20 receive the mailpiece data record within the scope of a push-oriented data transmission.

If a push-oriented data transmission of the mailing data record to a processing unit 20 that follows in the process order is provided for a processing unit 20, then the processing unit 20 consecutively attempts to transmit the mailing data record to the processing units 20 that follow in the process order and that are indicated in the section, whereby the order in which this is done is ascertained on the basis of the priorities that are assigned to the following processing units 20 in the section.

When a processing unit 20 retrieves the mailing data record within the scope of a push-oriented transmission from a processing unit 20 that precedes in the process order, then the processing unit 20, on the basis of the priorities of the processing unit 20 indicated in the section, attempts to consecutively retrieve the mailing data from the processing units 20 that precede in the process order and that are indicated in the section.

In both cases, the attempt to establish a data connection to a processing unit 20 having a higher priority is made when no data connection to the processing unit 20 with the next-lower priority could be established.

When several processing units 20 that precede or follow in the process order having different functionalities and having the same priority are present in the section, then a processing unit 20, on the basis of the prescribed transmission conditions, ascertains the other processing unit 20 from which the mailing data record is retrieved or to which the mailing data record is transmitted.

In order to retrieve a mailing data record of a preceding processing unit ascertained from the section in the manner described above or in order to transmit the mailing data to an ascertained following processing unit, a processing unit 20 needs the connection information for this preceding or following processing unit.

The active processing unit 20 retrieves this connection information from a load balancing unit 100 by means of a service request.

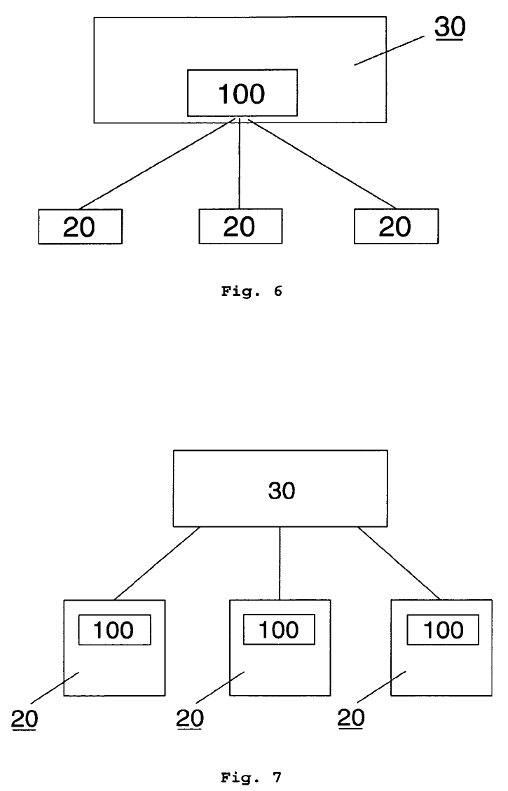

In a first embodiment of the invention, which is shown in FIG. 6, precisely one load balancing unit 100 is present in each mail processing center 10, whereby said load balancing unit 100 is preferably an integral part of the management unit 30 of the mail processing center 10.

In a second embodiment shown in FIG. 7, each processing unit 20 has its own load balancing unit 100. As shown in FIG. 7, it can be operated in the processing unit 20 or it can be only functionally and unambiguously associated with the processing unit 20 and can be integrated, for example, into the management unit 30.

The second embodiment has the advantage that connection information can be provided to the processing units 20, even in case of a temporary malfunction of the management unit 30, so that the availability of the entire system is enhanced.

The service lists of the existing processing unit groups are stored in a load balancing unit 100, these device lists being provided by the management unit 30 of that particular mail processing center 10.

The service lists are either transmitted to the load balancing unit 100 by the management unit 30 or else the service lists are retrieved from the management unit 30.

Preferably, this is done at regular intervals so that a load balancing unit 100 always has the current service lists available. Moreover, as an alternative or additionally, it can also provided that a management unit 30 transmits the service lists to a load balancing unit 100 if they have changed because a processing unit 20 has logged on or logged off.

In the second embodiment, in which each processing unit 20 has its own load balancing unit 100, it can also be provided that the only service lists stored in this equalization unit 100 are those that are relevant for the associated processing unit 20, i.e. to which this processing unit 20 transmits mailing data records or from which it retrieves mailing data records.

The transmission conditions that exist for the different preceding and following processing units indicate which service lists or processing unit groups are relevant here.

The service request that is transmitted from a first processing unit 20 to the load balancing unit 100 of the mail processing center 10 or to its own load balancing unit 100 contains especially information about the functionality of a second processing unit 20 that was ascertained from the section in the described manner and to which a data connection is to be established.

Moreover, in the service request, one or more mail processing centers 10 can be specified where the second processing unit 20 to which a data connection is to be established is to be located. Here, the request can especially relate to the processing unit's own mail processing center 10.

As a result, it is possible that, in spite of the existence of a global processing unit group, mailing data records are processed within prescribed mail processing centers 10.

For example, in this manner, mailing data records can be sent from the mail processing center 10 in which the outgoing sorting is carried out to the mail processing center 10 in which the incoming sorting takes place.

Moreover, on the basis of this information, a mailing data record that is processed by a processing unit 20 of a global processing unit group that is not located in the mail processing center 10 in which the physical mailpiece is being processed can be sent back to this mail processing center 10 where it can then be processed in further processing steps and especially can be transferred to a sorting machine.

When the load balancing unit 100 receives a service request, it first ascertains the service list for the functionality indicated in the service request.

Then, from the ascertained service list, the connection information is ascertained by means of a load balancing process.

In a preferred embodiment, the load balancing process is based on the so-called round-robin method, which, in principle, is known to the person skilled in the art.

In this process, the processing units 20 of a processing unit group are cyclically loaded in a prescribed order. For example, if the processing units 1, 2, 3 and 4 are available in a processing unit group, then they are loaded in the order 1, 2, 3, 4, 1, 2, 3, 4, etc.

If a global service list has been ascertained in this process from which the connection information is ascertained, and if the service request contains information about a specific mail processing center 10, then the round-robin method is modified in such a way that only connection information for processing units 20 of the indicated mail processing center 10 is taken into account and that the other connection information contained in the service list is skipped.

At a processing unit 20 whose connection information has been ascertained by means of the round-robin method, the load balancing unit 100 then sends a status query in order to determine the availability of this processing unit 20.

If the processing unit 20 then feeds back the status “logged on”, then the load balancing unit 100 transmits the connection information for this processing unit 20 within a response to the service request to the processing unit 20 from which the service request had come.

If the processing unit 20 to which the status query was sent reports the status “overloaded”, “temporarily logged off” or “logged off”, or if no response to the status query is received within a specified period of time, then the load balancing unit 100 ascertains the next connection information in the service list on the basis of the round-robin method and, once again, checks the status of the appertaining processing unit 20.

The status “temporarily logged off” is provided so that processing units 20 can be taken out of operation for a short period of time, for example, during maintenance work that is to be carried out quickly without a need to log off from the management unit 30.

Connection information for processing units 20 for which the status “overloaded” or “temporarily logged off” has been ascertained or from wich no response to the status query has been received within a specified period of time is taken into account during subsequent service requests, once again in accordance with the round-robin method.

Connection information for processing units 20 for which the status “logged off” has been ascertained is preferably only taken into account again when the load balancing unit 100 has received an updated service list from the management unit 30 or from its grouping component 50 in which this connection information is contained.

On the basis of the connection information received from the load balancing unit 100, the processing unit 20 from which the service request came establishes a data connection to another processing unit 20.

Depending on whether a push-oriented or pull-oriented data transmission is provided, the mailing data record is transmitted to the other processing unit 20 or else it is retrieved from the other processing unit 20.

If no processing unit 20 corresponding to the service request can be ascertained, then an error message is transmitted to the processing unit 20 from which the service request came.

This error message also contains information about the reason why no processing unit 20 corresponding to the service request could be ascertained.

If the reason is that all of the processing units 20 registered in the management unit 30 that meet the service request have fed back the status “overloaded” or “temporarily logged off” and are thus only briefly unavailable, then, in a preferred embodiment of the invention, it is provided that the processing unit 20 from which the service request came can register for a notification event in the event handler 60 of the management unit 30 of the same mail processing center 10.

In response to the registration, the service request is transmitted to the event handler 60.

If at least one processing unit 20 corresponding to the service request is available again, then a message is transmitted to the processing unit 20.

The message can contain the connection information for the processing unit 20 that is available again, so that a data connection can be established to this processing unit 20. However, it can also be provided that a processing unit 20 once again transmits the service request to the load balancing unit 100 when the message has been received.

Moreover, a message is also transmitted to a processing unit 20 that is registered in the event handler 60 for a notification event when all of the processing units 20 that correspond to the service request have logged off.

### LIST OF REFERENCE NUMERALS

10, 11, 12 mail processing center
20 processing unit
30 management unit
40 PcO manager
50 grouping component
60 event handler
70 lease manager
80A local processing unit group for functionality A
80B, 81B local processing unit group for functionality B
81C local processing unit group for functionality C
90B local processing unit group for functionality B
90C local processing unit group for functionality C
100 load balancing unit
410 ascertaining the functionality of a processing unit
420 checking whether a service PcO for the same functionality is already present
430 incorporating the service PcO into the process order
440 ascertaining the generation date of the service PcO
450 checking whether the generation date of the service PcO is more recent than that of an existing service PcO for the same functionality
460 discarding the service PcO
470 checking whether the service PcO was incorporated correctly into the process order

1-28. (canceled)

29. A method for processing a mailpiece in a data network having a plurality of processing units connected to each other within the data network, wherein an image of a surface of the mailpiece is recorded in a first one of the plurality of processing units, and wherein mailing data associated with the mailpiece is ascertained from the image of the surface in other of the plurality of processing units, and wherein a process order is determined in which the mailing data is ascertained by the plurality of processing units, the method comprising:
storing first information about a second one of the plurality of processing units, the second one of the plurality of processing units either preceding or following the first one of the plurality of processing units in the process order;
providing connection information for establishing a data connection between the first one of the plurality of processing units and the second one of the plurality of processing units, the connection information being associated with the first information; and
employing the connection information to establish a data connection between the first one of the plurality of processing units and the second one of the plurality of processing units to transmit the image therebetween.

30. The method according to claim 29, wherein the plurality of processing units are distributed among at least two different mail processing centers.

31. The method according to claim 29, wherein the image of the surface of the mailpiece is stored in a mailing data record that is augmented in the plurality of processing units by the mailing data ascertained from the image.

32. The method according to claim 31, comprising transmitting the mailing data record between the first one of the plurality of processing units and the second one of the plurality of processing units via the data connection.

33. The method according to claim 29, comprising:
transmitting the first information from the first one of the plurality of processing units to a management unit;
associating the connection information with the first information in the management unit; and
transmitting the connection information from the management unit to the first one of the plurality of processing units.

34. The method according to claim 29, comprising:
transmitting the connection information from a management unit to the first one of the plurality of processing units; and
associating the connection information with the first information in the first one of the plurality of processing units.

35. The method according to claim 29, wherein the first information comprises information about the functionality of the second one of the plurality of processing units.

36. The method according to claim 29, wherein each of the plurality of processing units is adapted to log on to a management unit.

37. The method according to claim 36, comprising transmitting first registration information to the management unit from a one of the plurality of processing units that has logged on to the management unit, the first registration information comprising information about a functionality of the one of the plurality of processing units and connection information for establishing a data connection to the one of the plurality of processing units.

38. The method according to claim 29, employing first registration information to associate the connection information with the first information.

39. The method according to claim 29, wherein each of the plurality of processing units is adapted to log on to a management unit, and wherein registration information is transmitted to the management unit from the first one of the plurality of processing units responsive to the first one of the plurality of processing units being logged on to the management unit, the registration information comprising information about the second one of the plurality of processing units.

40. The method according to claim 29, comprising recalculating the process order on the basis of registration information received by a management unit.

41. The method according to claim 29, comprising transmitting the process order to each of the plurality of processing units.

42. The method according to claim 41, comprising employing the process order by a third one of the plurality of processing units to ascertain first information about another of the plurality of processing units that precede or follow the third one of the plurality of processing units in the process order.

43. The method according to claim 29, wherein the first information comprises information about all of the plurality of processing units that precede the first one of the plurality of processing unit in the process order and from which a mailing data record has been retrieved.

44. The method according to claim 29, wherein the first information comprises information about all of the plurality of processing units that follow the first one of the plurality of processing unit in the process order and from which a mailing data record has been transmitted.

45. The method according to claim 29, comprising assigning a priority to first information about another of the plurality of processing units that follow the first one of the plurality of processing units in the process order, the priority being reduced in an order in which the another of the plurality of processing units follows the first one of the plurality of processing units.

46. The method according to claim 29, comprising assigning a priority to first information about another of the plurality of processing units that precede the first one of the plurality of processing units in the process order, the priority being reduced in an order in which the another of the plurality of processing units precedes the first one of the plurality of processing units.

47. The method according to claim 29, wherein the first one of the plurality of processing units is adapted to establish a data connection with a third one of the plurality of processing units having a lower priority that precedes or follows in the process order relative to the first one of the plurality of processing units if establishment of a data connection to a fourth one of the plurality of processing units having a higher priority that precedes or follows in the process order is unsuccessful.

48. The method according to claim 29, wherein the first one of the plurality of processing units is adapted to store transmission conditions under which a mailing data record is transmitted to or retrieved from a given one of the plurality of processing units that precedes or follows the first one of the plurality of processing units.

49. The method according to claim 48, wherein the transmission conditions refer to mailing data contained in the mailing data record.

50. The method according to claim 29, comprising storing first information about a third one of the plurality of processing units, the third one of the plurality of processing units either preceding or following the first one of the plurality of processing units in the process order, the third one of the plurality of processing units having a different functionality relative to the second one of the plurality of processing units, wherein different transmission conditions are assigned to the third one of the plurality of processing units relative to the second one of the plurality of processing units.

51. The method according to claim 29, comprising storing first information about a third one of the plurality of processing units, the third one of the plurality of processing units either preceding or following the first one of the plurality of processing units in the process order, the third one of the plurality of processing units having a different functionality relative to the second one of the plurality of processing units, wherein the same priority is assigned to the second one of the plurality of processing units relative to the third one of the plurality of processing units and wherein different transmission conditions are assigned to the third one of the plurality of processing units relative to the second one of the plurality of processing units.

52. The method according to claim 29, comprising ascertaining a third one of the plurality of processing units to which a mailing data record has been transmitted by the first one of the plurality of processing units or from which a mailing data record has been retrieved by the first one of the plurality of processing units on the basis of transmission conditions specified for the third one of the plurality of processing units.

53. The method according to claim 29, wherein the plurality of processing units are distributed among at least two different mail processing centers, and wherein a management unit is located in each of the at least two mail processing centers, and wherein each one of the plurality of processing units is adapted to log on to the management unit located in the same one of the at least two mail processing center as the each one of the plurality of processing units.

54. The method according to claim 29, wherein the data network comprises a plurality of management units that are each adapted to exchange registration information about at least one of the plurality of processing units.

55. The method according to claim 29, wherein the first one of the plurality of processing units is adapted to transmit the first information to a management unit located in a mail center in which the first one of the plurality of processing units is also located.

56. The method according to claim 29, wherein the connection information comprises a network address of the second one of the plurality of processing units.

57. A data network that is adapted to process a mailpiece, the data network having a plurality of processing units connected to each other within the data network, wherein an image of a surface of the mailpiece is recorded in a first one of the plurality of processing units, and wherein mailing data associated with the mailpiece is ascertained from the image of the surface in other of the plurality of processing units, and wherein a process order is determined in which the mailing data is ascertained by the plurality of processing units, the data network comprising:
means for storing first information about a second one of the plurality of processing units, the second one of the plurality of processing units either preceding or following the first one of the plurality of processing units in the process order;
means for providing connection information for establishing a data connection between the first one of the plurality of processing units and the second one of the plurality of processing units, the connection information being associated with the first information; and
means for employing the connection information to establish a data connection between the first one of the plurality of processing units and the second one of the plurality of processing units to transmit the image therebetween.

58. A tantible machine-readable medium that is adapted to be used in a data network that processes a mailpiece, the data network having a plurality of processing units connected to each other within the data network, wherein an image of a surface of the mailpiece is recorded in a first one of the plurality of processing units, and wherein mailing data associated with the mailpiece is ascertained from the image of the surface in other of the plurality of processing units, and wherein a process order is determined in which the mailing data is ascertained by the plurality of processing units, the tangible machine-readable medium comprising:
machine-readable instructions adapted to store first information about a second one of the plurality of processing units, the second one of the plurality of processing units either preceding or following the first one of the plurality of processing units in the process order;
machine-readable instructions adapted to provide connection information for establishing a data connection between the first one of the plurality of processing units and the second one of the plurality of processing units, the connection information being associated with the first information; and
machine-readable instructions adapted to employ the connection information to establish a data connection between the first one of the plurality of processing units and the second one of the plurality of processing units to transmit the image therebetween.
